(19) United States
(12) Patent Application Publication
(10) Pub. No.: US 2012/0316734 A1
(43) Pub. Date: Dec. 13, 2012

(54) ALERT SOUND OUTPUT CONTROL APPARATUS, ALERT SOUND OUTPUT CONTROL METHOD AND COMPUTER PRODUCT

(75) Inventor: Haruhiko Takagi, Shanghai (CN)

(73) Assignee: PIONEER CORPORATION

(21) Appl. No.: 13/579,821

(22) PCT Filed: Mar. 31, 2010
(86) PCT No.: PCT/JP2010/055975

§ 371 Date: Aug. 17, 2012

(51) Int. Cl. B60Q 5/00; G08G 1/00

(52) U.S. Cl. 701/45

(57) ABSTRACT

An alert sound output control apparatus provides audio data to a speaker unit that outputs an alert sound directed outside a vehicle. The alert sound output control apparatus includes a road information acquiring unit that acquires lane count information for a road being traveled by the vehicle; a position information acquiring unit that acquires traveling position information for the vehicle; and an output unit that based on the lane count information and the traveling position information, controls output of the alert sound directed outside the vehicle.

### TECHNICAL FIELD

The present invention relates to an alert sound output apparatus equipped on an electric automobile, an alert sound output method, an alert sound output program and a recording medium of the alert sound output apparatus. Nonetheless, use of the present invention is not limited to the alert sound output apparatus, the alert sound output method, the alert sound output program and the recording medium.

### BACKGROUND ART

The development of electric automobiles powered by electricity rather than gasoline, hybrid automobiles, and fuel cell powered vehicles (hereinafter, “electric automobiles”) is advancing. Compared to conventional gasoline engine driven automobiles, electric automobiles have a characteristic of running quietly, making the presence of a nearby electric automobile difficult to detect by, for example, pedestrians.

To address this problem, a known technology outputs an alert (e.g., a pseudo engine sound) directed outside the vehicle and prompting awareness among nearby pedestrians (see, for example, Patent Document 1). In the technology disclosed in Patent Document 1, when a person (a pedestrian, etc.) or a mobile object (a vehicle, etc.) in proximity of an automobile is detected as a notification target, based on the output from a human detection sensor and a mobile object detection sensor, the time required for the distance between the notification target and the automobile to become a minimum distance is estimated based on the distance between the notification target and the automobile as well as the relative speed between the notification target and the automobile, and when the estimated time becomes less than or equal to a preliminarily set threshold period, an operation is performed of outputting from a light emitting diode, a warning in the form of a flashing light in the direction of the notification target.

Another known technology, for example, enables a temporary stopping position to be set even for an intersection traveled by the driver for the first time, where the driver is given a warning according to the distance between the intersection and the vehicle (see, for example, Patent Document 2).

Patent Document 1: Japanese Laid-Open Patent Publication No. 2006-209325

Patent Document 2: Japanese Laid-Open Patent Publication No. 2007-334548

### DISCLOSURE OF INVENTION

Problem to be Solved by the Invention

Nonetheless, one example of a problem with the technology according to Patent Document 1 above is that warnings are given without consideration of the surrounding environment of the vehicle. For example, an inadvertent warning on a street in a residential neighborhood has the potential of causing noise issues among residents. Meanwhile, a majority of the roads in residential areas are narrow streets having 1 lane or less for each direction of travel, along which the distance between traveling vehicles and pedestrians is short; and thus, accidents easily occur. Therefore, pedestrians need to be alerted of the presence of the vehicle at a proper timing.

One example of a problem arising with the technology according to Patent Document 1 is that although a pedestrian is detected by a sensor and a warning is issued, sufficient accuracy cannot be expected of such sensors at present. Further, even if a sensor of which sufficient accuracy can be expected is provided, a problem arises in that the cost of the apparatus becomes high.

### Means for Solving Problem

To solve the problems above and achieve an object, an alert sound output apparatus according to the invention of claim 1 is an alert sound output apparatus equipped on a vehicle and includes a road information acquiring unit that acquires lane count information for a road being traveled by the vehicle; a position information acquiring unit that acquires traveling position information of the vehicle for the road; and an output unit that based on the lane count information and the traveling position information, outputs an alert sound directed outside the vehicle.

An alert sound output method according to the invention of claim 8 is for an alert sound output apparatus equipped on a vehicle and includes a road information acquiring step of acquiring lane count information for a road being traveled by the vehicle; a position information acquiring step of acquiring traveling position information for the vehicle; and an output step of outputting an alert sound directed outside the vehicle, based on the lane count information and the traveling position information.

An alert sound output program according to the invention of claim 9 causes a computer to execute the alert sound output method according to claim 8.

A computer-readable recording medium according to the invention of claim 10 stores the alert sound output program according to claim 9.

### BRIEF DESCRIPTION OF DRAWINGS

FIG. 1 is a block diagram of a functional configuration of an alert sound output apparatus according to an embodiment;

FIG. 2 is a flowchart depicting an alert sound output process performed by alert sound output apparatus;

FIG. 3 is a block diagram of a hardware configuration of a navigation apparatus;

FIG. 4 is a flowchart of a pseudo-engine-sound output process performed by the pseudo-engine-sound output apparatus; and

FIG. 5 is a diagram depicting, along a horizontal axis, output timing of a pseudo engine sound.

### BEST MODE(S) FOR CARRYING OUT THE INVENTION

With reference to the accompanying drawings, preferred embodiments of an alert sound output apparatus, an alert sound output method, an alert sound output program, and a recording medium according the present invention will be described in detail.

### Embodiment

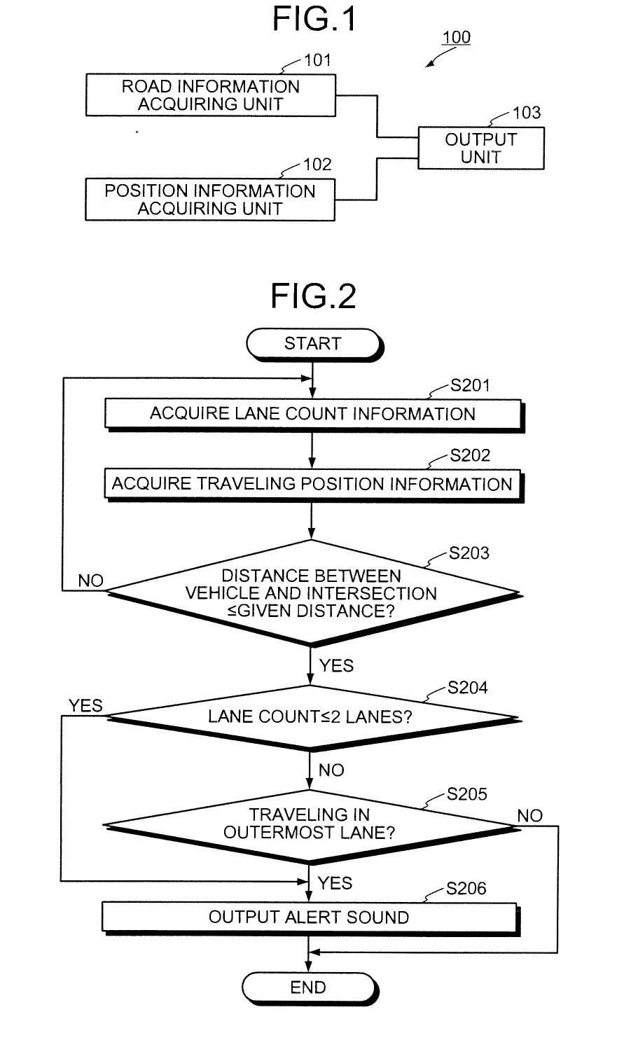

FIG. 1 is a block diagram of a functional configuration of an alert sound output apparatus according to an embodiment. An the alert sound output apparatus 100 according to the embodiment is equipped on a non-depicted vehicle, and includes a road information acquiring unit 101, a position information acquiring unit 102, and an output unit 103.

The road information acquiring unit 101 acquires lane count information for the road along which the vehicle is traveling. Lane count information is information that indicates the number of lanes on a road and can express, for example, single-lane (a road along which the lanes for vehicles traveling in different directions are not demarcated), 1 lane for each direction of travel (2 lanes total), 2 lanes for each direction of travel (4 lanes total), etc. In addition to the lane count for the road being traveled by the vehicle, the road information acquiring unit 101 may acquire information indicating whether the area along which vehicles travel and the area along which other mobile objects travel (pedestrians, etc.) are separated. The road information acquiring unit 101 acquires the lane count information by, for example, reading lane count information included in map data, determining the lane count of the road by image recognition, etc.

Further, the road information acquiring unit 101 may acquire position information for intersections on the road being traveled by the vehicle and information related to whether a signal is present at the intersections. The road information acquiring unit 101 acquires the information by, for example, reading intersection position information and signal information included in map data, determining intersection positions and the presence of signals by image recognition, etc.

The road information acquiring unit 101 may further acquire information related to the width of the road being traveled by the vehicle. The road information acquiring unit 101 acquires information related to road width by, for example, reading road width information included in map data, determining the road width by image recognition, etc.

The road information acquiring unit 101 may further acquire information related to the average traffic volume of the road being traveled by the vehicle. The road information acquiring unit 101 acquires the information related to the average traffic volume by reading average traffic volume information included in map data, receiving average traffic volume information from an information delivery server that provides traffic information in real-time, etc.

The position information acquiring unit 102 acquires traveling position information for the vehicle. The position information acquiring unit 102, for example, uses OPS information received from a GPS satellite, vehicular traveling speed information, acceleration information, etc. to acquire the vehicular traveling position information. The position information acquiring unit 102 may acquire traveling position information from a navigation apparatus equipped on the vehicle. The position information acquiring unit 102 acquires on-road vehicular traveling position information. On-road vehicular traveling position information is, for example, information indicating in which lane the vehicle is traveling among the lanes of the road being traveled.

The output unit 103 outputs an alert sound directed outside the vehicle, based on the lane count information acquired by the road information acquiring unit 101 and the traveling position information acquired by the position information acquiring unit 102. The output unit 103, for example, generates the alert sound when the lane count of the road is 1 or less lanes for each direction. On such roads, the distance between the vehicle and pedestrians is short, and minor accidents easily occur. The output unit 103 may be configured to output the alert sound only when the lane count for the road is 1 or less lanes for each direction and the width of the road is a given value or less, or when the lane count for the road is 1 or less lanes for each direction and the average traffic volume is a given volume or less. Roads with a low traffic volume are generally narrow and thus, minor accidents easily occur.

The output unit 103 may be configured to output the alert sound when the lane count of the road is more than 1 lane for each direction and the vehicle is traveling in the outermost lane, e.g., the lane nearest the outer shoulder of the road. On roads having multiple lanes for each direction of travel, bicycles often travel along the shoulder of the road and sidewalks are often provided. Dangers such as contact with bicycles or pedestrians can be prevented by an output of the alert sound to inform bicyclists and pedestrians of the presence of the vehicle.

The output unit 103, for example, outputs the alert sound when the distance between the vehicle and an intersection on the road has become a given distance or less. Here, for example, if no signal is present at the intersection, configuration may be such that the output unit 103 outputs the alert sound. The alert sound is output near an intersection in this manner since a pedestrian or an automobile, etc. (hereinafter, “pedestrian”) may be traveling along an intersecting road or a pedestrian traveling along the same road as the vehicle may enter the lane to confirm that the intersection is safe to enter. Dangers such as collisions with pedestrians can be prevented by outputting the alert sound from the output unit 103 to inform pedestrians of the presence of the vehicle.

The alert sound output by the output unit 103 may be, for example, a pseudo engine sound of the vehicle, a klaxon, an electronically generated sound, etc. Further, the volume, the frequency, and the output cycle of alert sound may be changed according to the distance between the vehicle and the intersection.

An alert sound output process performed by the alert sound output apparatus 100 will be described. FIG. 2 is a flowchart depicting the alert sound output process performed by alert sound output apparatus. In the flowchart depicted in FIG. 2, the alert sound output apparatus 100 acquires, via the road information acquiring unit 101, lane count information for the road being traveled by the vehicle (step S201). The alert sound output apparatus 100 acquires, via the position information acquiring unit 102, vehicular traveling position information (step S202).

The alert sound output apparatus 100 determines whether the distance between the vehicle and an intersection has become at most a given distance (step S203). If the distance between the vehicle and the intersection is not the given distance or less (step S203: NO), the alert sound output apparatus 100 returns to step S201 and repeats the operations therefrom. If the distance between the vehicle and the intersection is the given distance or less (step S203: YES), the alert sound output apparatus 100 judges whether the lane count of the road being traveled by the vehicle is at most 1 lane for each direction (step S204).

If the lane count is 1 or less lanes for each direction (step S204: YES), the alert sound output apparatus 100 transitions to step S206. If the lane count is not 1 or less lanes for each direction (step S204: NO), the alert sound output apparatus 100 determines whether the vehicle is traveling in the outermost lane (step S205).

If the vehicle is traveling in the outermost lane (step S205: YES), the alert sound output apparatus 100 outputs, via the output unit 103, the alert sound (step S206), ending the operations according to the flowchart. If the vehicle is not traveling in the outermost lane (step S205: NO), the alert sound output apparatus 100 ends the operations according to the flowchart, without outputting the alert sound.

As described, based on lane count information for the road being traveled by the vehicle and vehicular traveling position information, the alert sound output apparatus 100 outputs alert sounds directed to be heard outside the vehicle. For example, when the lane count of the road being traveled by the vehicle is 1 or less lanes for each direction, the alert sound output apparatus 100 outputs the alert sound. Further, roads of 1 or less lanes for each direction have a relatively narrow width and thus, on such roads, the distance between the vehicle and a pedestrian is short and the risk of contact is high. Along such roads, the risk of contact or collision between the vehicle and a pedestrian can be reduced by an output of the alert sound.

Meanwhile, since the alert sound output apparatus 100 outputs the alert sound only when given conditions are satisfied (e.g., the traveled road has 1 or less lanes for each direction, the distance between the vehicle and an intersection is a given distance or less, etc.), compared to continuous output of the alert sound, the potential of the alert sound becoming undesirable noise (a nuisance) can be reduced. Further, if configuration is such that determination of whether to output the alert sound is performed at the alert sound output apparatus 100, the frequency of output of the alert sound can be further reduced.

The alert sound output apparatus 100 outputs the alert sound when the lane count of the traveled road is more than 1 lane for each direction and the vehicle is traveling in the outermost lane. On roads having multiple lanes for each direction of travel, bicycles often travel along the shoulder of the road and sidewalks are often provided. In such places, dangers such as contact with bicycles or pedestrians can be prevented by an output of the alert sound to inform bicyclists and pedestrians of the presence of the vehicle.

The alert sound output apparatus 100 outputs the alert sound when the distance between the vehicle and an intersection becomes a given distance or less. At intersections, the risk of contact and/or collision is high since other mobile objects may dart out from an intersecting road and the potential of another mobile object entering the same lane as the vehicle is high. Dangers of contact and/or collision at intersections can be reduced by an output of the alert sound near the intersection by the alert sound output apparatus 100.

If configuration is such that at the alert sound output apparatus 100, the alert sound is output only when no signal is present at an intersection, the frequency of alert sound output in places where the alert sound may become a nuisance can be further reduced and the safety of intersections that have no signals and a particularly high risk of contact and/or collisions can be improved.

### Example

An example of the present invention will be described. As one example, a case will be described where the invention is applied by implementing the alert sound output apparatus 100 according to the embodiment as a pseudo-engine-sound output apparatus 300 equipped on a vehicle. The pseudo-engine-sound output apparatus 300 according to the example is assumed to be equipped on a vehicle, such as an electric automobile, a hybrid automobile, and a fuel cell powered vehicle, that does not generate driving sounds of an engine.

### (Hardware Configuration of Pseudo-Engine-Sound Output Apparatus 300)

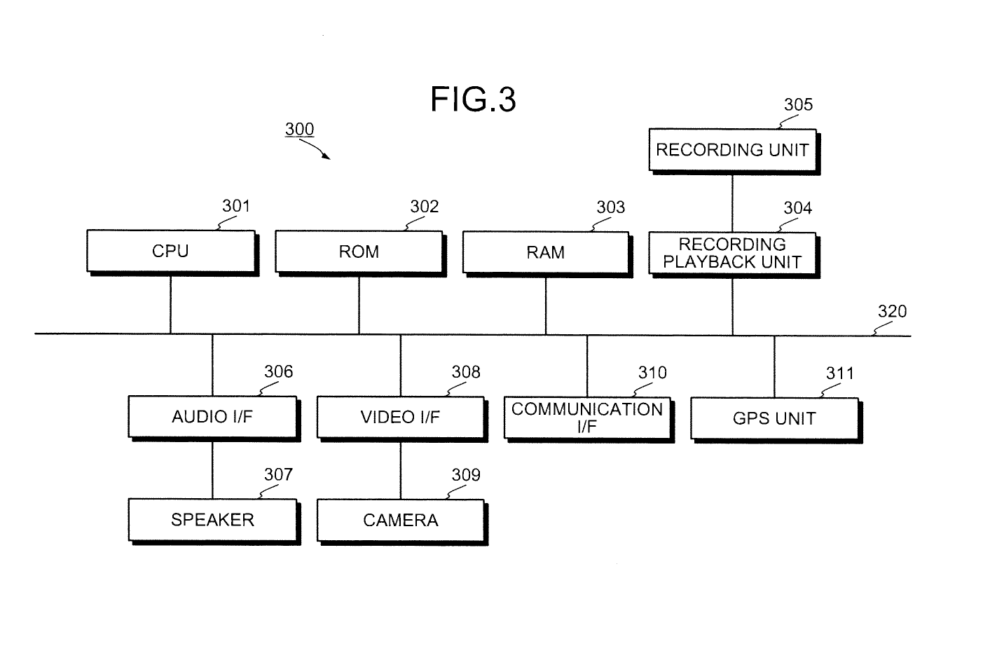

FIG. 3 is a block diagram of a hardware configuration of a navigation apparatus. The pseudo-engine-sound output apparatus 300 according to the example includes a CPU 301, ROM 302, RAM 303, a recording playback unit 304 that records and plays back various types of data, a recording unit 305 that records various types of data, an audio I/F 306, a speaker 307, a video I/F 308, a camera 309, a communication I/F 310, and a GPS unit 311, respectively connected by a bus 320.

The CPU 301 governs overall control of the pseudo-engine-sound output apparatus 300. The ROM 302 stores various types of programs such as a boot program, a position detection program, and an engine sound control program. The RAM 303 is used as a work area of the CPU 301, i.e., the CPU 301 uses the RAM 303 as a work area while executing the programs recorded in the ROM 302 and thereby, governs overall control of the pseudo-engine-sound output apparatus 300.

The recording playback unit 304, under the control of the CPU 301, controls the reading and writing of data with respect to the recording unit 305. The recording unit 305 records data written thereto under the control of the recording playback unit 304. For example, a magnetic disk drive or an optical disk drive may be used as the recording playback unit 304; and for example, a hard disk (HD), a flexible disk (FD), flash memory, an MO, solid stat disk (SSD), a memory card, etc. may be used as the recording unit 305.

An example of the information recorded to the recording unit 305 is map data (map database). Map data is used in an engine sound generating process performed by the engine sound control program. Map data includes at least road shape data that describes the shapes of roads. Road shape data includes traffic control data. Traffic control data, for example, is information indicating for each node, the presence of signals and crosswalks, entrances and exits of expressways, the presence of junctions, and is information indicating for each link, the length (distance), the road width, the lane count, the direction of travel, and the road type (expressway, toll road, general road, etc.). In addition, map data may include background data that describes terrestrial objects (features) such as buildings, rivers, land surfaces, etc.

The audio I/F 306 is connected to the speaker 307, which is for audio output. The audio I/F 306 D/A converts audio data that has been specified for playback and causes the converted audio data to be output from the speaker 307 as sound. The speaker 307 may be detachable from the pseudo-engine-sound output apparatus 300 and may be located at a position away from the main body of the pseudo-engine-sound output apparatus 300.

The video I/F 308 is connected to the camera 309. The video I/F 308 is made up of, for example, buffer memory such as Video RAM (VRAM) that temporarily stores image information captured by the camera 309, and a control IC that controls the display 313 based on image data output from the graphic controller.

The camera 309 captures images outside the vehicle on which the pseudo-engine-sound output apparatus 300 is equipped. Images captured by the camera 309 may be still images or video. Images captured by the camera 309 are recorded to the recording unit 305, via the video I/F 308.

The communication I/F 310 is wirelessly connected to a network and is capable of data communication via the network. Use of the communication I/F 310 enables the pseudo-engine-sound output apparatus 300 to acquire, via the network, information that changes in real-time, such as road congestion information, traffic volume information, etc. Further, configuration may be such that map data is received using the communication I/F 310. The communication network may be a LAN, a WAN, a public line network, a mobile telephone network, etc.

The GPS unit 311 receives signals from GPS satellites and outputs information indicating the current position of the vehicle on which the pseudo-engine-sound output apparatus 300 is equipped. The GPS unit 311 includes various types of sensors such as a vehicular speed sensor, an acceleration sensor, and an angular speed sensor. The information output by the GPS unit 311 is used by the CPU 301 in the calculation of the current position of the pseudo-engine-sound output apparatus 300. Information indicating the current position is, for example, information identifying a single point on the map data such as such as latitude/longitude, altitude, etc.

Functions of the components of the alert sound output apparatus 100 depicted in FIG. 1 are implemented by using the programs and data recorded in the ROM 302, the RAM 303, the recording unit 305, etc. depicted in FIG. 3 to execute given programs on the CPU 301 and thereby, control each component.

### (Pseudo-Engine-Sound Generating Process Performed by Pseudo-Engine-Sound Output Apparatus 300)

A pseudo-engine-sound generating process performed by the pseudo-engine-sound output apparatus 300 will be described. As described above, the pseudo-engine-sound output apparatus 300 is equipped on a vehicle, such as an electric automobile, a hybrid automobile, and a fuel cell powered vehicle, that does not generate driving sounds of an engine. While this type of vehicle has the advantage of not causing undesirable noise, this type of vehicle also has the problem of being dangerous since the presence of the vehicle is difficult to detect by nearby pedestrians. Therefore, a pseudo engine sound is output around the vehicle and nearby pedestrians are informed of the proximity of the vehicle.

If the pseudo engine sound is continuously output, the advantage of not causing undesirable noise while in motion is lost. Thus, the pseudo-engine-sound output apparatus 300 outputs the pseudo engine sound with consideration of the lane count and road type of the road being traveled by the vehicle, the traveling position of the vehicle, etc., whereby the output of the pseudo engine sound can be limited to only required places, thereby maintaining the advantage of electric automobiles of not causing undesirable noise and enabling the danger to pedestrians to be prevented.

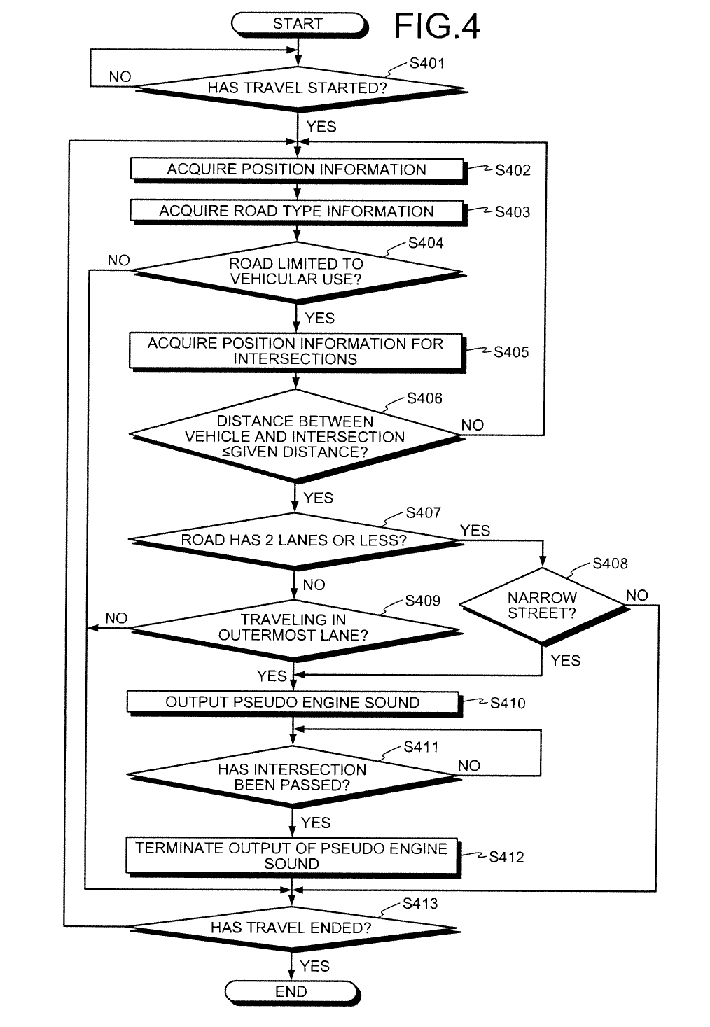

FIG. 4 is a flowchart of a pseudo-engine-sound output process performed by the pseudo-engine-sound output apparatus. In the flowchart depicted in FIG. 4, the pseudo-engine-sound output apparatus 300 waits until the vehicle on which the pseudo-engine-sound output apparatus 300 is equipped starts to travel (step S401: NO). When the vehicle starts to travel (step S401: YES), the pseudo-engine-sound output apparatus 300 uses information output from the GPS unit 311 and acquires the current vehicular position (step S402).

The pseudo-engine-sound output apparatus 300 acquires road type information for the road being traveled by the vehicle (step S403). Based on the position information calculated at step S402, the pseudo-engine-sound output apparatus 300, for example, refers to map data corresponding to the current position and reads the road type information. The road type information is information indicating the type (road limited to vehicular use, expressway, toll road, general road, etc.) of the road.

The pseudo-engine-sound output apparatus 300 determines based on the road type information, whether the road being traveled by the vehicle is limited to vehicular use (step S404), and if so (step S404: YES), transitions to step S413. In this case, on roads limited to vehicular use, only other automobiles are traveling nearby and therefore, no merit can be gained by outputting the pseudo engine sound.

On the other hand, if the road being traveled by the vehicle is not limited to vehicular use (step S404: NO), the pseudo-engine-sound output apparatus 300 acquires position information for an intersection located ahead in the traveling direction of the vehicle (step S405), and determines whether the distance between the current vehicular position and the intersection is at most a given distance (step S406). The intersection position information is, for example, read from the map data recorded in the recording unit 305, or calculated by image analysis of images captured by the camera 309.

If the distance between the vehicle and the intersection is not the given distance or less (step S406: NO), i.e., if the distance between the vehicle and the intersection is sufficient, the pseudo-engine-sound output apparatus 300 returns to step S402 and repeats the operations therefrom.

If the distance between the vehicle and the intersection is the given distance or less (step S406: YES), the pseudo-engine-sound output apparatus 300 determines whether the road being traveled by the vehicle has at most 1 lane for each direction (step S407). A road that has 1 lane for each direction is a road having 1 lane for each opposing traveling direction. Further, a road that has less than 1 lane for each direction is, for example, a single-lane road along which the lanes for vehicles traveling in different directions are not demarcated, or a single-lane, one-way road.

If the road being traveled by the vehicle has 1 or less lanes for each direction (step 5407: YES), the pseudo-engine-sound output apparatus 300 determines whether the road is a narrow street (step S408). Here, a narrow street is a road that has a narrow width and is relatively difficult to transit. Narrow streets are often present in residential areas and when traveled by the vehicle, sufficient attention must be given in terms of inadvertent contact of nearby pedestrians.

The determination of whether the road is a narrow street is performed by, for example, reading road information from the map data, calculating the width of the road by image recognition and determining the road to be a narrow street when the calculated width is a given width or less. Further, for example, the average traffic volume information (included in the map data) for the road may be read or received via the communication I/F 310 and when the average traffic volume is a given number or less, the road is determined to be a narrow street. The average traffic volume has a high potential of varying temporally and configuration may be such that the average traffic information for the time that the vehicle travels the road is used to determine whether the road is a narrow street. Further, if the road type information included in the map data has information indicating whether a road is a narrow street, the information may be used.

If the road is a narrow street (step S408: YES), the pseudo-engine-sound output apparatus 300 transitions to step S410. If the road is not a narrow street (step S408: NO), the pseudo-engine-sound output apparatus 300 transitions to step S413.

At step S407, if the road being traveled by the vehicle does not have 1 or less lanes for each direction (step S407: NO), i.e., when the road has multiple lanes for each direction of travel, the pseudo-engine-sound output apparatus 300 determines whether the vehicle is traveling in the outermost lane (step S409). On roads having multiple lanes for each direction of travel, bicycles often travel along the shoulder of the road and sidewalks are often provided. Thus, there is a risk of contact along such roads.

If the vehicle is traveling in the outermost lane, the pseudo-engine-sound output apparatus 300 may continuously output the engine sound irrespective of whether an intersection is present. Road having multiple lanes for each direction of travel are relatively large roads and compared to narrow streets, the effects of undesirable noise on nearby areas is low. On the other hand, on such roads, the potential of the vehicle and bicycles traveling at high speeds is high and a serious accident resulting from contact during travel has the potential to occur. Such accidents during travel can be prevented from occurring by a continuous output of the engine sound while the vehicle is traveling in the outermost lane.

If the vehicle is traveling in the outermost lane (step S409: YES), or if the road being traveled by the vehicle is a narrow street (step S408: YES), the pseudo-engine-sound output apparatus 300 outputs the pseudo engine sound directed to be heard outside the vehicle (step S410). Until the intersection is passed (step S411: NO), the pseudo-engine-sound output apparatus 300 returns to step S410 and continues to output the pseudo engine sound. When the intersection is passed (step S411: YES), the pseudo-engine-sound output apparatus 300 terminates the output of the pseudo engine sound (step S412).

If the vehicle is not traveling in the outermost lane (step S409: NO), or if the road is not a narrow street (step S408: NO), the pseudo-engine-sound output apparatus 300 transitions to step S413, without outputting the pseudo engine sound.

Until the vehicle stops traveling (step S413: NO), the pseudo-engine-sound output apparatus 300 returns to step S402 and repeats the operations therefrom. When the vehicle stops traveling (step S413: YES), the pseudo-engine-sound output apparatus 300 ends the process according to the flowchart.

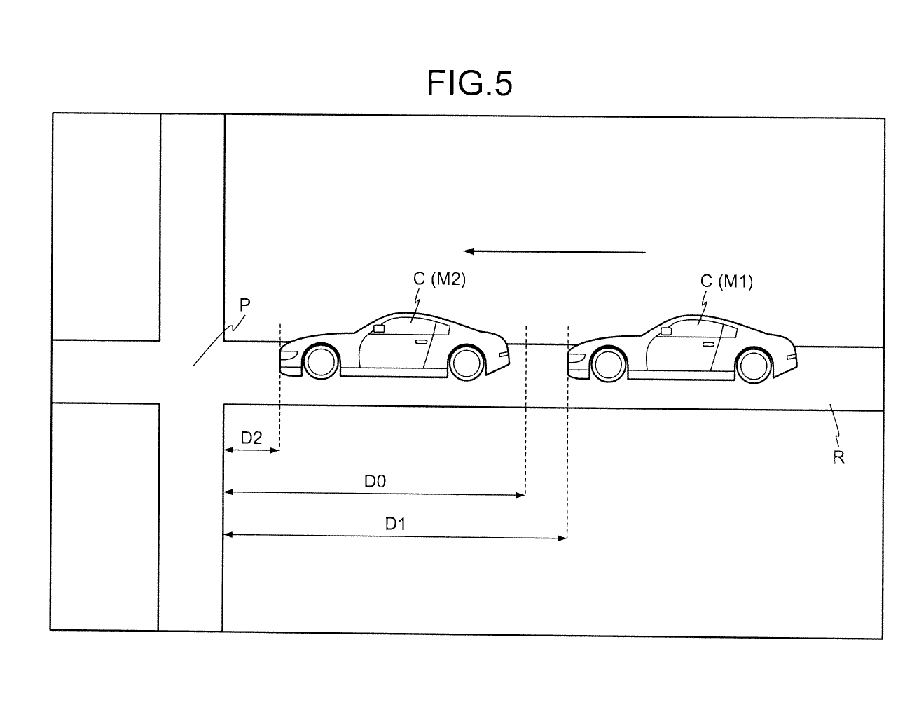

FIG. 5 is a diagram depicting, along a horizontal axis, the output timing of the pseudo engine sound. Vehicle C is traveling along road R and ahead in the traveling direction of vehicle C, intersection P is present. When the distance between vehicle C and intersection P is a given distance (e.g., distance D0) or less, vehicle C begins to output the pseudo engine sound. In FIG. 5, when vehicle C is at position M1, since the distance between vehicle C and intersection P is a distance D1, which is greater than the distance D0, the pseudo engine sound is not output. On the other hand, when vehicle C is at position M2, since the distance between vehicle C and intersection P is a distance D2, which is less than or equal to the distance D0, the pseudo engine sound is output.

In addition to being universally established, the distance DO may be determined with consideration of, for example, the speed of and/or the time of travel of vehicle C, the weather, the width of road R, etc. For example, the faster the speed of travel, the greater the distance DO is set. Furthermore, during times (such as early morning or at night) when the surroundings are dark or during inclement weather (such as rain, snow, strong winds, etc.), the distance D0 is set to be greater than for other conditions. The narrower the width of road R is, the greater the distance D0 may be set.

Determination of whether to output the pseudo engine sound, for example, may be determined with consideration of the speed of and/or the time of travel of vehicle C, the weather, the width of road R, etc. For example, when the speed of travel of vehicle C is a given speed or greater, the pseudo engine sound is output; and when the speed is less than the given speed, the pseudo engine sound is not output. During times (such as early morning or at night) when the surroundings are dark or during inclement weather, the pseudo engine sound is output; and for other conditions, the pseudo engine sound is not output.

After the distance between vehicle C and intersection P becomes the distance D0 or less, vehicle C may vary the volume or the form of the pseudo engine sound output until intersection P is passed. For example, as the distance between vehicle C and intersection P decreases, the pseudo engine sound may be output at a higher volume, a higher frequency, and/or at shorter intervals. Thus, nearby pedestrians can be more assuredly informed of the presence of vehicle C.

Further, the pseudo engine sound may be output with consideration of whether a signal is present at intersection P. For example, if a signal is present at intersection P, the pseudo engine sound is not output; and when no signal is present, the pseudo engine sound is output since the risk of a pedestrian darting out from an intersecting road is high at intersections without a signal.

Although in the present example, nearby pedestrians are informed of the presence of the vehicle by the output of a pseudo engine sound, configuration is not limited hereto and for example, a klaxon or other electronically generated sound may be output.

As described, the pseudo-engine-sound output apparatus 300 outputs the pseudo engine sound directed to be heard outside the vehicle, based on lane count information for the road being traveled by the vehicle and vehicular traveling position information. For example, if the road being traveled by the vehicle has 1 or less lanes for each direction, the pseudo engine sound is output. Roads having 1 or less lanes for each direction also have a relatively narrow width, and on such roads, the distance between the vehicle and a pedestrian is short and the risk of contact is high. Along such roads, the risk of contact or collision between the vehicle and a pedestrian can be reduced by an output of the alert sound.

Meanwhile, the pseudo-engine-sound output apparatus 300 outputs the pseudo engine sound only when given conditions are satisfied (e.g., the traveled road has 1 or less lanes for each direction, the distance between the vehicle and an intersection is a given distance or less, etc.). Thus, compared to continuous output of the pseudo engine sound, the potential of the pseudo engine sound becoming undesirable noise (a nuisance) can be reduced and safety can be improved without sacrificing the advantage of electric automobiles of not causing undesirable noise. Further, the frequency of the output of the pseudo engine sound can be reduced by determining, at the pseudo-engine-sound output apparatus 300, whether the road is a narrow street, based on the width and traffic volume of the road.

The pseudo-engine-sound output apparatus 300 outputs the pseudo engine sound when the road being traveled by the vehicle has more than 1 lane for each direction and the vehicle is traveling in the outermost lane. On roads having multiple lanes for each direction of travel, bicycles often travel along the shoulder of the road and sidewalks are often provided. Dangers such as contact with bicycles or pedestrians can be prevented by an output of the pseudo engine sound to inform bicyclists and pedestrians of the presence of the vehicle.

The pseudo-engine-sound output apparatus 300 outputs the pseudo engine sound when the distance between the vehicle and an intersection becomes a given distance or less. At intersections, the risk of contact and/or collision is high since other mobile objects may dart out from an intersecting road and the potential of another mobile object entering the same lane as the vehicle is high. Dangers of contact and/or collision at intersections can be reduced by an output of the pseudo engine sound near the intersection by the pseudo-engine-sound output apparatus 300.

If configuration is such that at the pseudo-engine-sound output apparatus 300, the pseudo engine sound is output only when no signal is present at an intersection, the frequency of the output of the pseudo engine sound in places where the pseudo engine sound may become a nuisance can be further reduced and the safety of intersections that have no signals and a particularly high risk of contact and/or collisions can be improved.

The alert sound generating method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

### EXPLANATIONS OF LETTERS OR NUMERALS

100 alert sound output apparatus
101 road information acquiring unit
102 position information acquiring unit
103 output unit

1-10. (canceled)

11. An alert sound output control apparatus providing audio data to a speaker unit that outputs an alert sound directed outside a vehicle, the alert sound output control apparatus comprising:
a road information acquiring unit that acquires lane count information for a road being traveled by the vehicle;
a position information acquiring unit that acquires traveling position information for the vehicle; and
an output unit that based on the lane count information and the traveling position information, controls output of the alert sound directed outside the vehicle.

12. An alert sound output control method of an alert sound output control apparatus that provides audio data to a speaker unit that outputs an alert sound directed outside a vehicle, the alert sound output control method comprising:
acquiring lane count information for a road being traveled by the vehicle;
acquiring traveling position information for the vehicle; and
controlling, based on the lane count information and the traveling position information, output of the alert sound directed outside the vehicle.

13. A computer-readable recording medium storing an alert sound output control program that causes a computer to execute:
acquiring lane count information for a road being traveled by the vehicle;
acquiring traveling position information for the vehicle; and
controlling, based on the lane count information and the traveling position information, output of the alert sound directed outside the vehicle.
